(19) United States
(12) Patent Application Publication
(10) Pub. No.: US 2011/0079754 A1
(43) Pub. Date: Apr. 7, 2011

(54) Fabricating method of nano-powder and application thereof

(75) Inventors: Tsung-Eong Hsieh, Hsinchu City (TW); Chun-Chieh Lo, Hsinchu County (TW); Yin-Hsien Huang, Hsinchu City (TW); Chuang-Hung Chiu, Hsinchu County (TW); Mei-Tsao Chiang, Taoyuan County (TW); Huai-An Li, Taoyuan County (TW); Chi-Neng Mo, Taoyuan County (TW)

(73) Assignee: Chunghwa Picture Tubes, LTD., Taoyuan (TW)

(21) Appl. No.: 12/653,069

(22) Filed: Dec. 7, 2009

(30) Foreign Application Priority Data
Oct. 2, 2009 (TW) 98133569

(51) Int. Cl. H01B 1/12

(52) U.S. Cl. 252/519.33; 977/900

(57) ABSTRACT

A fabricating method of nano-powder is provided. First, a mixture having at least a first material and a second material is provided. Then, the mixture is sintered to obtain a single phase alloy body. After that, the single phase alloy body is pre-crumbled to obtain a powder to be ground. Then, a chemical dispersant is added into the powder to further be ground, so as to obtain the nano-powder.

### CROSS-REFERENCE TO RELATED APPLICATION

This application claims the priority benefit of Taiwan application serial no. 98133569, filed Oct. 2, 2009. The entirety of the above-mentioned patent application is hereby incorporated by reference herein and made a part of specification.

### BACKGROUND OF THE INVENTION

1. Field of the Invention

The invention is related to a fabricating method of nano-powder, and particularly to a fabricating method of nano-powder which is capable of preparing nano-powder with desired chemical composition.

2. Description of Related Art

Large display panels are the trend in current developments of the display industry, but large display panels require larger processing platforms for film coating and photolithographic processes, so that difficulties in maintaining yield have increased. In order to overcome the above difficulties, researchers have introduced printing techniques, i.e. after printing a printed pattern at a suitable position by utilizing a conductive slurry, an adequate process (such as heat process) is further implemented on the printed pattern to form a conductive thin film.

Printing techniques may be used to fabricate a channel layer of a thin film transistor or a transparent pixel electrode of a flat panel display. In particular, printing techniques have the advantages of omitting the photolithographic processes, being able to be used with computer aided drawing designing (CAD) and program controlling to fabricate patterns of any shapes, not being affected by differences in heights of substrates, being reworkable, and having great flexibility in the processes, thereby having great potential. However, the printing slurry is the key in printing techniques.

FIG. 1 is a schematic diagram showing a flowchart of a conventional printing technique. Referring to FIG. 1, steps S101 to S103 show processes of preparing a printing slurry, and steps S104 to S107 show processes of using the printing slurry to fabricate a conductive thin film.

First, as shown in the steps S101 to S103, the preparation of the printing slurry is generally conducted by adopting a chemical reaction method. In other words, a sol-gel solution which includes a precursor containing zinc oxide (ZnO) and a surfactant is mixed with deionized water, and a solution (i.e., the printing slurry) containing ZnO metal salt is obtained. The above precursor may be zinc acetate (Zn(CH₃COO)₂.2H₂O) or zinc nitrate (Zn(NO₃)₂.6H₂O). Next, as shown in the steps S104 to S107, the printing slurry is printed or spin coated on a substrate. After a suitable heating process (such as pre-baking or post-baking), a ZnO conductive thin film is formed.

Additionally, a chemical bath deposition (CBD) method may be used to form the conductive thin film, i.e. by soaking a substrate in a plating solution (at about 60° C.) which contains zinc nitride and dimethylamine borane of a suitable ratio. The thickness of the conductive thin film may be adjusted by controlling the concentration of the precursor. Then, after baking at about 100° C., the ZnO conductive thin film is obtained.

The above chemical reaction method has easy processes and has been reported in various publications. However, the temperature during the subsequent heating process is often greater than several hundreds of degrees centigrade, thereby being unfavorable to the application in processing of a flexible substrate. It should be noted that the above chemical reaction method is more suitable for fabricating a conductive thin film which only contains ZnO. If a ZnO thin film doped with other elements (such as indium, aluminum, or magnesium) or a ZnO thin film (such as InGaZnO (IGZO)) having multiple compositions is to be prepared, since the different elements or compositions have different redox reaction rates, the chemical composition of the final product is not easily controlled, so that applications thereof are limited.

### SUMMARY OF THE INVENTION

In light of the above, the invention provides a fabricating method of nano-powder which is capable of preparing nano-powder of desired chemical composition.

The invention also provides a preparation method of a nano-powder slurry which is capable of preparing a nano-powder slurry which has nano-powder of desired chemical composition.

The invention provides a fabricating method of nano-powder. First, a mixture having at least a first material and a second material is provided. Then, the mixture is sintered, so as to obtain a single phase alloy body. Next, the single phase alloy body is pre-crumbled to obtain a powder to be ground. A chemical dispersant is added to the powder to be ground, and the powder to be ground with the chemical dispersant is ground, so as to obtain the nano-powder.

According to an embodiment of the invention, the first material is zinc oxide, and the second material includes indium oxide, aluminum oxide, or magnesium oxide.

According to an embodiment of the invention, the above mixture further includes a third material. The first material is zinc oxide, the second material is indium oxide, and the third material is gallium oxide. In addition, a composition molar ratio of zinc oxide to indium oxide to gallium oxide is 2:1:1.

According to an embodiment of the invention, the first material is barium oxide, and the second material is titanium oxide.

According to an embodiment of the invention, the temperature for sintering the mixture is from 900° C. to 1,500° C.

According to an embodiment of the invention, the duration of sintering the mixture is from 4 hours to 8 hours.

According to an embodiment of the invention, the step of pre-crumbling the single phase alloy body includes the following steps. First, perform a mechanical grinding process on the single phase alloy body, and the rotational speed of the mechanical grinding process is from 2,400 revolutions per minute (rpm) to 3,600 rpm, and the duration of the mechanical grinding process is from 8 to 12 hours.

According to an embodiment of the invention, the above chemical dispersant includes sodium polymethacrylate (PMMA-Na) or polyacrylamide/(-N,N-dimethyl-N-acryloyloxyethyl) ammonium ethanate (PDAAE).

According to an embodiment of the invention, in the total weight of the powder to be ground and the chemical dispersant, the weight percentage of the chemical dispersant is from 0.1 wt % to 5 wt %.

According to an embodiment of the invention, the fabricating method of the nano-powder further includes adding deionized water to the powder to be ground, so as to form a slurry. A pH adjuster may be added to the powder to be ground, so that the pH value is from 8 to 9. And, in the total weight of the powder to be ground, the chemical dispersant, the deionized water and the pH adjuster, the weight percentage of the powder to be ground is from 15 wt % to 35 wt %.

According to an embodiment of the invention, the step of adding the chemical dispersant to the powder to be ground and grinding the powder to be ground with the chemical dispersant includes performing a mechanical grinding process on the powder to be ground, and the rotational speed of the mechanical grinding process is from 2,400 rpm to 3,600 rpm, and the duration of the mechanical grinding process is from 30 minutes to 90 minutes.

The invention also provides a preparation method of a nano-powder slurry. First, the above fabricating method of nano-powder is used to obtain the nano-powder. Then, a solution is added to the nano-powder, so as to obtain the nano-powder slurry.

According to an embodiment of the invention, the above solution includes a chemical dispersant and deionized water.

Due to the above, the nano-powder fabricated by combining the sintering process, the chemical dispersant and the mechanical grinding process has advantages of having various chemical compositions, having a narrow distribution of the particle sizes, being easily fabricated, and being easy for mass production. The nano-powder is easily used in subsequent applications.

In order to make the aforementioned and other features and advantages of the invention more comprehensible, embodiments accompanying figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram showing a flowchart of a conventional printing technique.

FIG. 2 is a schematic diagram showing a flowchart of a fabricating method of nano-powder according to the first embodiment of the invention.

FIG. 3 is relationship diagram showing a curve of concentrations of a chemical dispersant verses average particle sizes in a slurry.

FIG. 4(a) is a micrograph showing particles before a chemical dispersant is added.

FIG. 4(b) is a micrograph showing particles after a chemical dispersant is added.

FIG. 5 is a schematic diagram showing a flowchart of a fabricating method of nano-powder according to the second embodiment of the invention.

FIG. 6 is a schematic diagram showing a flowchart of a fabricating method of nano-powder according to the third embodiment of the invention.

FIG. 7 is a schematic diagram showing a flowchart of a preparation method of a nano-powder slurry according to an embodiment of the invention.

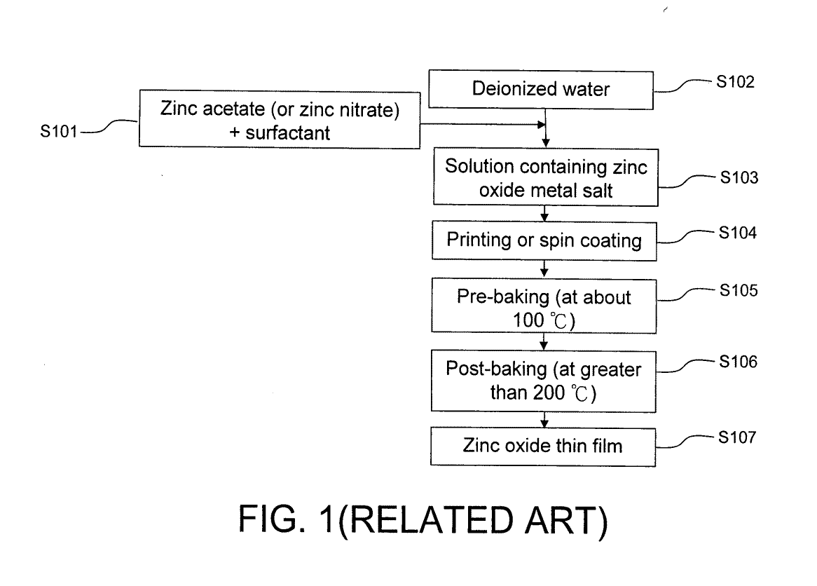

### DESCRIPTION OF EMBODIMENTS

A fabricating method of nano-powder of the invention is capable of preparing nano-powder of desired chemical composition. In detail, different kinds of original powder are mixed, and a suitable sintering process is performed to obtain a single phase alloy body. Then, a mechanical grinding process and a chemical dispersant are used in cooperation to grind the single phase alloy body, so that a nano-powder having multiple materials and any chemical composition is obtained. The obtained nano-powder is capable of being used as a printing slurry, and a conductive pattern is easily fabricated by using a printing technique with the obtained nano-powder. Several embodiments are described below to illustrate the fabricating method of nano-powder of the invention and applications thereof.

### Fabricating Method of Nano-Powder

### First Embodiment

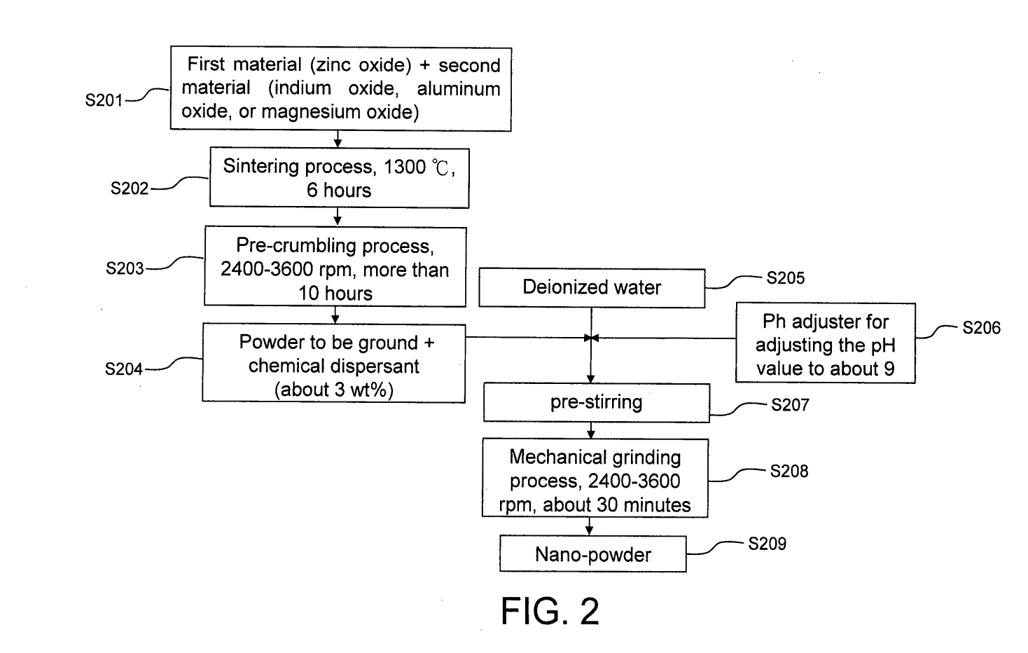

FIG. 2 is a schematic diagram showing a flowchart of a fabricating method of nano-powder according to the first embodiment of the invention. Referring to FIG. 2, a fabricating method of nano-powder 200 substantially includes steps S201 to S209. First, as shown in the step S201, a mixture having at least a first material and a second material is provided. According to the present embodiment, the first material may be zinc oxide, and the second material may be indium oxide, aluminum oxide, or magnesium oxide.

Nano-powders of zinc oxide, indium oxide, aluminum oxide, and magnesium are commercially available. However, if sizes of the powders are not nanometer-grade, a preliminary mechanical grinding process may be performed. Particularly, in the step S201, the amounts of the first material and the second material that are added are determined according to a specific chemical composition. In a step of solely mixing solid powders, redox reactions do not occur between different solid powders, so that the chemical composition of the final product is precisely controlled, and problems stemming from conventional chemical reactions do not occur.

Next, as shown in the step S202, the mixture is sintered to obtain the single phase alloy body. The temperature for sintering the mixture may be from 900° C. to 1,500° C., preferably 1,300° C., and the duration of sintering the mixture may be from 4 hours to 8 hours, preferably 6 hours. Since the respective amounts of the first material and the second material that are added are already determined in the step S201, in the sintering process of the step S202, the single phase alloy body of the specific chemical composition is also obtained.

Next, as shown in the step S203, the single phase alloy body is pre-crumbled to obtain a powder to be ground. The step of pre-crumbling the single phase alloy body includes the following processes. First, a mechanical grinding process is performed on the single phase alloy body, and the rotational speed of the mechanical grinding process is from 2,400 revolutions per minute (rpm) to 3,600 rpm, and the duration of the mechanical grinding process is from 8 to 12 hours, preferably from 10 to 12 hours.

Afterwards, as shown in the steps S204 to S209, a chemical dispersant is added to the powder to be ground and the powder with the chemical dispersant are ground, so as to obtain the nano-powder. Through collocation of the first material and the second material, zinc oxide mixtures of In:ZnO (IZO), Al:ZnO (AZO), or Mg:ZnO, having different additives, are obtained.

In particular, the chemical dispersant used in the step S204 includes sodium polymethacrylate (PMMA-Na) or polyacrylamide/(-N,N-dimethyl-N-acryloyloxyethyl) ammonium ethanate (PDAAE).

In further detail, in order to obtain the powder having nanometer sizes, a wet grinding method may be used. In the so-called wet grinding method, the powder to be ground is mixed with a suitable solvent into a slurry, and the chemical dispersant is used for dispersion, so as to prevent aggregation of the powder during the grinding process. In said embodiment, as shown in the step S205, deionized water may be added to the powder to be ground, so as to adjust the viscosity of the slurry and facilitate the wet grinding process. In addition, as shown in the step S206, a pH adjuster may also be added to the powder to be ground, so that the pH value is from 8 to 9, thereby preventing precipitation in the powder to be ground.

Still referring to FIG. 2, in the step S207, when the slurry is prepared, the slurry may be pre-stirred. In the total weight of the powder to be ground, the chemical dispersant, the deionized water and the pH adjuster, the weight percentage of the powder to be ground is from 15 wt % to 35 wt %. The reason why the solid weight (which is the content of the powder to be ground) in the slurry needs to be controlled from 15 wt % to 35 wt % is for prevention of an increase in viscosity during the mechanical grinding process caused by an increase in the specific surface area (SSA) of the powder to be ground. Therefore, superb effects of grinding and dispersing the particles are achieved.

As shown in the step S208, in the step of performing the mechanical grinding process on the powder to be ground which has the chemical dispersant added therein, the rotational speed of the mechanical grinding process may be from 2,400 rpm to 3,600 rpm, and the duration of the mechanical grinding process may be from 30 minutes to 90 minutes, preferably 30 minutes. Hence, the nano-powder having the specific chemical composition in the step S209 is obtained. The mechanical grinding process may be performed by using a common ball grinder. The rotational speed of the ball grinder is controlled to make grinding balls (which may have a material such as zirconium oxide) rotate and slide, so as to achieve effects of grinding and dispersing the powder to be ground.

Whether the grinding and dispersing leads to a nanometer grade is related to parameters such as the composition of the slurry, the size of the grinding media (i.e., the grinding balls), the grinding conditions, and the mechanism of dispersing by the chemical dispersant. According to actual operating experiences, the grinding balls which are selected may have sizes from 0.3 millimeters (mm) to 0.5 mm or less (depending on the capability of the grinding machine). In order to continuously and effectively reduce the size of the powder, the tangential speed of a mixing stick must exceed 10 meters per second (m/sec). The viscosity of the slurry must also be adjusted to below 100 centipoises (cps), so that motions of the grinding balls are not affected by the viscosity of slurry.

It should be noted that, in the total weight of the powder to be ground and the chemical dispersant, the weight percentage of the chemical dispersant is from 0.1 wt % to 5 wt %, preferably 3 wt %. The weight percentage of the chemical dispersant is determined, so to obtain good dispersing effects and to effectively reduce particle sizes during grinding.

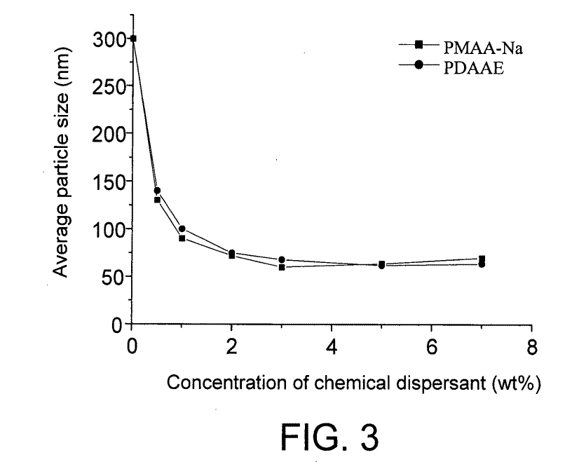

FIG. 3 is relationship diagram showing a curve of concentrations of a chemical dispersant verses average particle sizes in a slurry. Referring to FIG. 3, the chemical dispersant may be PMMA-Na or PDAAE. PMMA-Na is a cation type dispersant, and the main functional group (COO—) obtained after a hydrolysis reaction is used to provide electric charge repelling forces as the mechanism for dispersion of the particles. Besides, PDAAE simultaneously provides electric charge repelling forces and steric hindrance, thereby achieving similar effects as PMMA-Na.

Still referring to FIG. 3, the average particle size in the slurry before the chemical dispersant is added is 300 nanometers (nm). As the chemical dispersant is added, the average particle size gradually decreases. By adding about 3 wt % of the chemical dispersant, the smallest average particle size, about 70 nm, is achieved. When the concentration of the chemical dispersant exceeds 3 wt %, the average particle size increases. This is because the excessive amount of chemical dispersant causes a bridge effect, thereby causing the average particle size to increase.

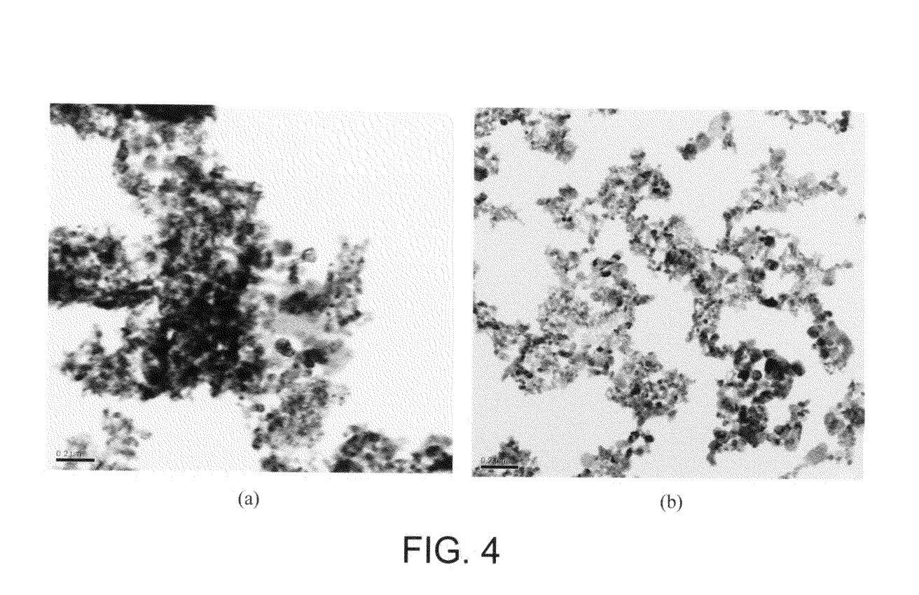

FIG. 4(a) is a micrograph showing particles before a chemical dispersant is added. FIG. 4(b) is a micrograph showing particles after a chemical dispersant is added. By comparing FIGS. 4(a) and 4(b), it is clearly known that in the mechanical grinding method facilitated by the chemical dispersant, the particles are effectively ground and dispersed. In contrast, in FIG. 4(a), the particles aggregate together, so that good dispersing effects are not achieved.

In summary, in the above fabricating method of nano-powder, different kinds (at least two kinds) of original powder are mixed, and the suitable sintering process is performed to obtain the single phase alloy body. Then, the mechanical grinding process and the chemical dispersant are used in cooperation to grind the single phase alloy body, so that the nano-powder having desired chemical composition is obtained. Moreover, the nano-powder that is obtained has characteristics of high purity, small particle sizes, and a narrow distribution of the particle sizes. In particular, the above fabricating method of nano-powder is suitable for mass production.

### Second Embodiment

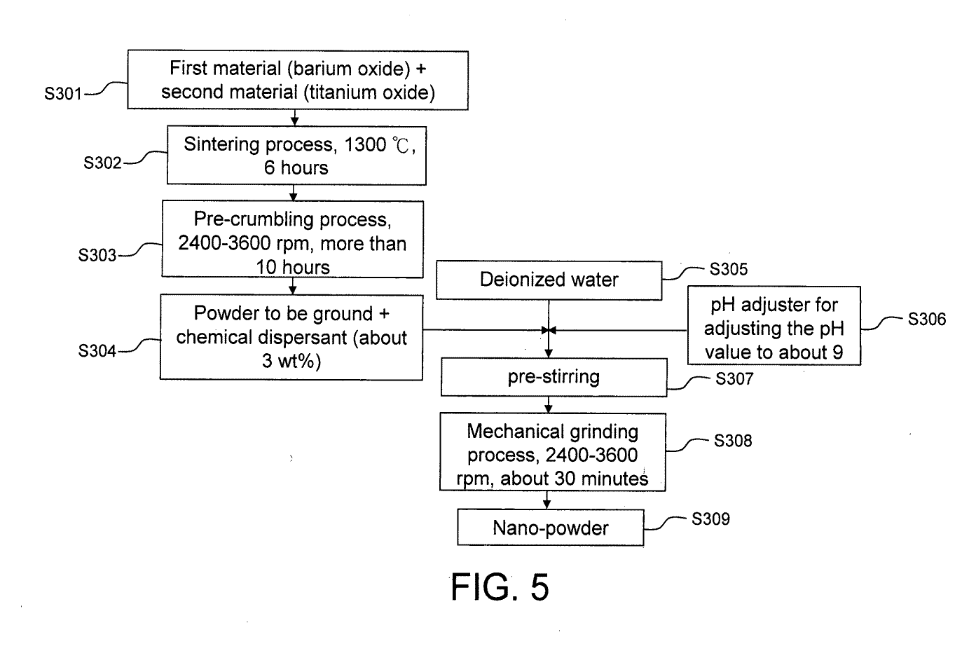

FIG. 5 is a schematic diagram showing a flowchart of a fabricating method of nano-powder according to the second embodiment of the invention. The fabricating method of nano-powder shown in FIG. 5 includes steps S301 to S309, and relevant content is similar to the fabricating method of nano-powder shown in FIG. 2, and is not repeatedly described.

It should be noted that, in the step S301, a mixture having at least a first material and a second material is provided. According to the present embodiment, the first material is barium oxide, and the second material is titanium oxide. Subsequently, after the steps S302 to S309, the nano-powder of barium titanium oxide (BaTiO₃) is obtained.

### The Third Embodiment

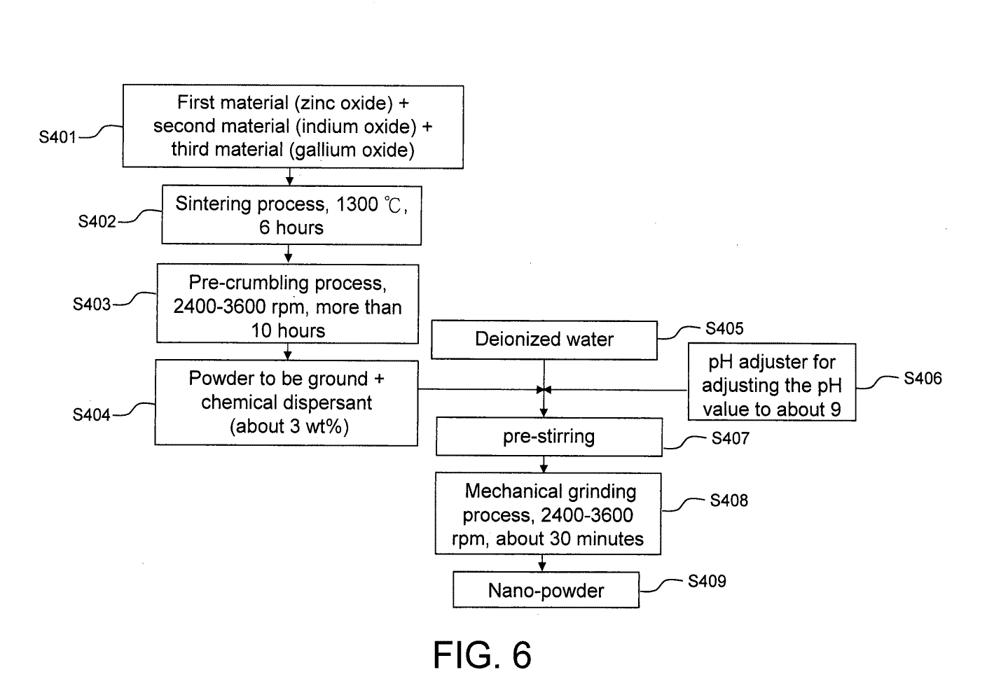

FIG. 6 is a schematic diagram showing a flowchart of a fabricating method of nano-powder according to the third embodiment of the invention. The fabricating method of nano-powder shown in FIG. 6 includes steps S401 to S409, and relevant content is similar to the fabricating method of nano-powder shown in FIG. 2, and is not repeatedly described.

It should be noted that, in the step S401, a mixture having at least a first material, a second material, and a third material is provided. According to the present embodiment, the first material is zinc oxide (ZnO), the second material is indium oxide (In₂O₃), and the third material is gallium oxide (Ga₂O₃). In the present embodiment, a preferable composition molar ratio of zinc oxide to indium oxide to gallium oxide is 2:1:1. Subsequently, after the steps S302 to S309, the nano-powder of indium gallium zinc oxide (IGZO) is obtained.

In further detail, the approximately processes are as follows. Original powders such as ZnO, In₂O₃, and Ga₂O₃ are first mixed at a suitable ratio. Next, after a sintering process at 1,300° C. for 6 hours, a single InGaZnO phase is obtained. After pre-crumbling to form the powder to be ground, the deionized water and the chemical dispersant of a suitable ratio are added to form a slurry, and the mixing stick which rotates in the high speed grinding machine is used to transmit power to the grinding balls which have a suitable size. After the slurry is propelled into a grinding chamber by a pump, the Van der Waal's force between powder particles is overcome by the shear force generated by the relative movement between the grinding balls, so that the chemical dispersant is able to enter between powder particles to achieve the purpose of dispersing.

In addition, the ratio of mixing the ZnO, In₂O₃, and Ga₂O₃ may be changed in the step S401, so that a nano-powder of IGZO which has a different chemical composition is obtained, such as In₂Ga₂ZnO₇ or InGaZnO₄.

### [Fabricating Method of Nano-Powder Slurry]

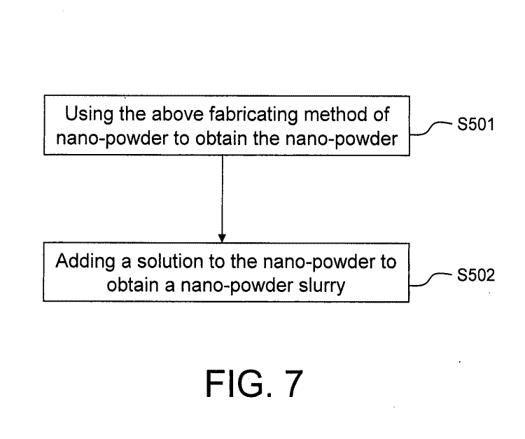

FIG. 7 is a schematic diagram showing a flowchart of a preparation method of a nano-powder slurry according to an embodiment of the invention. Please refer to FIG. 7 first, in step 501, the above fabricating method of nano-powder is used to obtain the nano-powder. Subsequently, in step S502, a solution is added to the nano-powder to obtain the nano-powder slurry. The solution may include the chemical dispersant and the deionized water.

The nano-powder slurry prepared by the above method may be used in a printing process, so as to fabricate a channel layer or pixel electrode of a thin film transistor, or to fabricate a passive capacitor device having a high dielectric constant, or to fabricate a sputtering target having micro-crystals and a high density via suitable molding and sintering processes.

In conclusion of above description, the fabricating method of nano-powder and the preparation method of the nano-powder slurry of the invention has at least the following advantages.

The nano-powder fabricated by combining the sintering process, the chemical dispersant and the mechanical grinding process has advantages of having various chemical compositions, having a narrow distribution of the particle sizes, being easily fabricated, and being easy for mass production. The nano-powder that is obtained may be used in subsequent processes. By adding a suitable solution, an ink slurry may be prepared, or a sputtering target having micro-crystals and a high density is produced via suitable molding and sintering processes.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A fabricating method of nano-powder, comprising:
providing a mixture, the mixture comprising at least a first material and a second material;
sintering the mixture, so as to obtain a single phase alloy body;
pre-crumbling the single phase alloy body, so as to obtain a powder to be ground; and
adding a chemical dispersant to the powder to be ground and grinding the powder to be ground with the chemical dispersant, so as to obtain the nano-powder.

2. The fabricating method of the nano-powder of claim 1, wherein the first material is zinc oxide, and
the second material comprises indium oxide, aluminum oxide, or magnesium oxide.

3. The fabricating method of the nano-powder of claim 1, wherein the mixture further comprises a third material;
the first material is zinc oxide, the second material is indium oxide, and the third material is gallium oxide.

4. The fabricating method of the nano-powder of claim 3, wherein a composition molar ratio of the zinc oxide to the indium oxide to the gallium oxide is 2:1:1.

5. The fabricating method of the nano-powder of claim 1, wherein the first material is barium oxide, and the second material is titanium oxide.

6. The fabricating method of the nano-powder of claim 1, wherein a temperature for sintering the mixture is from 900° C. to 1,500° C.

7. The fabricating method of the nano-powder of claim 1, wherein a duration of sintering the mixture is from 4 hours to 8 hours.

8. The fabricating method of the nano-powder of claim 1, wherein the step of pre-crumbling the single phase alloy body comprises:
performing a mechanical grinding process on the single phase alloy body, wherein a rotational speed of the mechanical grinding process is from 2,400 revolutions per minute (rpm) to 3,600 rpm, and the duration of the mechanical grinding process is from 8 to 12 hours.

9. The fabricating method of the nano-powder of claim 1, wherein the chemical dispersant comprises sodium polymethacrylate (PMMA-Na) or polyacrylamide/(-N,N-dimethyl-N-acryloyloxyethyl)ammonium ethanate (PDAAE).

10. The fabricating method of the nano-powder of claim 1, wherein in a total weight of the powder to be ground and the chemical dispersant, a weight percentage of the chemical dispersant is from 0.1 wt % to 5 wt %.

11. The fabricating method of the nano-powder of claim 1, further comprising adding a deionized water to the powder to be ground, so as to form a slurry.

12. The fabricating method of the nano-powder of claim 11, further comprising adding a pH adjuster to the powder to be ground, so that the pH value is from 8 to 9.

13. The fabricating method of the nano-powder of claim 12, wherein in a total weight of the powder to be ground, the chemical dispersant, the deionized water and the pH adjuster, a weight percentage of the powder to be ground is from 15 wt % to 35 wt %.

14. The fabricating method of the nano-powder of claim 1, wherein the step of adding the chemical dispersant to the powder to be ground and grinding the powder to be ground with the chemical dispersant comprises:
performing a mechanical grinding process on the powder to be ground, wherein a rotational speed of the mechanical grinding process is from 2,400 revolutions per minute (rpm) to 3,600 rpm, and the duration of the mechanical grinding process is from 30 to 90 minutes.

15. A preparation method of a nano-powder slurry, comprising:
using the nano-powder fabricated by the fabricating method of the nano-powder of claim 1; and
adding a solution to the nano-powder, so as to obtain the nano-powder slurry.

16. The preparation method of the nano-powder slurry of claim 15, wherein the solution comprises a chemical dispersant and deionized water.
